(19) United States
(12) Patent Application Publication
(10) Pub. No.: US 2009/0097944 A1
(43) Pub. Date: Apr. 16, 2009

(54) FIBRE-REINFORCED BINDING LAYER

(75) Inventors: Jan van den Berg, Gouda (NL); Wilhelmus Johannes Wesselink, Haarlem (NL)

Correspondence Address: YOUNG & THOMPSON, 209 Madison Street, Suite 500, ALEXANDRIA, VA, 22314, US

(73) Assignee: SDU INDENTIFICATION B.V., HAARLEM (NL)

(21) Appl. No.: 12/296,132

(22) PCT Filed: Apr. 4, 2007
(86) PCT No.: PCT/NL07/50139

§ 371 Date: Nov. 10, 2008

(30) Foreign Application Priority Data
Apr. 4, 2006 (NL) 1031513

(51) Int. Cl. B42C 11/00; B42D 1/00

(52) U.S. Cl. 412/4; 281/21.1

(57) ABSTRACT

Book-like construction (1) such as a passport with a number of pages including a non-hinged holder page. The non-hinged holder page (2) is composed of a relatively stiff material and has to be connected by a separate hinged part (5) to the remainder of the book-like construction (1). The hinged part (5) according to the invention is made of a fabric-reinforced plastic material in which the plastic can be fusible with the plastic of the non-hinged holder page (2). The fixing is carried out ultrasonically, and more particularly by providing surface irregularities on one of the two parts to be fixed to each other.

The present invention relates to a book-like construction according to the preamble of Claim 1.

Such a book-like construction is disclosed in FR 2194541. This publication describes a bound assembly, which is welded together ultrasonically by means of a thin strip.

Another application of such a book-like construction is, for example, a passport. In such a passport a large number of visa pages are present, as well as a cover. These are made of pivotable material. Furthermore, the more modern passports contain a so-called holder page or another page in which, for example, a chip or the like is present. Such a page is not hinged. For purposes of still being able to accommodate this page in a passport in a hinged manner, the prior art proposes fixing to it a hinged strip and then combining said strip with the other pages and the cover to form a passport. In the construction disclosed in EP 1008459 A1 (in the name of Enschedé/SDU B.V.) the strip is provided with recesses situated at regular intervals. A further strip is provided for example having projections that can extend through these openings. It is also possible to provide the holder page concerned with such projections. The strip of flexible material is clamped between the holder page and the strip placed on it. These last parts are fused together.

This is a complicated process because it is necessary to position the hinged sip accurately, since the projections concerned have to extend through the openings in the strip. Furthermore, it is necessary to position accurately the further part placed on the hinged strip. Moreover, this forms an additional part.

It is the object of the present invention to provide a construction in which the hinged part is fixed on the non-hinged part in a simple manner.

This object is achieved by the features and measures of Claim 1.

According to the present invention, the material of the hinged part is selected in such a way that it can fuse with the plastic from which the non-hinged part is made. This means that it is possible to dispense with the further strip that is used in the prior art. The process is preferably carried out by ultrasonic welding. In order to promote this ultrasonic welding, one of the two part to be connected to each other is preferably provided with surface irregularities such as ribs or ridges, so that energy is concentrated and the first fusing between the two parts can be started off more easily. In addition to or instead of fusing the hinged part and the first part, gluing or a mechanical connecting technique can be used for connecting these two parts. The term mechanical connecting technique is understood as meaning sewing, stapling and the like.

According to an advantageous embodiment of the invention, the hinged part is provided with a fibre-reinforced plastic material. This fibre is preferably provided in the form of a fibric such as a polyester fabric.

The connecting technique by fusing described above is preferably carried out with two of the same materials such as polycarbonate material. In order to position the hinged part on a level with the non-hinged part, the non-hinged part is preferably provided with a recess near the end concerned, for the purpose of accommodating the hinged part.

The invention also relates to a method for producing a first, non-hinged part mad of plastic material and a hinged part fixed to it, comprising providing a fabric reinforced hinged part providing a first part provided in an area with surface irregularities, placing said hinged part on said area with surface irregularities, and connecting said first part and said hinged part at that point. The connection can comprise gluing, welding or fusing, and is preferably carried out ultrasonically. The surface irregularities preferably comprise parallel ribs.

The fabric-reinforced material described above, which preferably comprises polyester fabric, according to an advantageous embodiment consists of at least one layer, and preferably two layers, of plastic material between which the fibric is pressed and fused with the material. The fabric is preferably placed between two layers of plastic material such as two layers of polycarbonate material, and a single layer of fibric-reinforced material is obtained by pressing such as laminating.

An example that can be given is a layer thickness of always 50 μm for polycarbonate and a layer thickness of approximately 100 μm for the fabric. After pressing, a fabric-reinforced material with a thickness of approximately 150 μm is therefore obtained, which material is capable of being welded in an extremely simple manner to a holder page of a non-hinged part of some document such as a passport.

The invention will be explained below with reference to an exemplary embodiment shown in the drawing, in which:

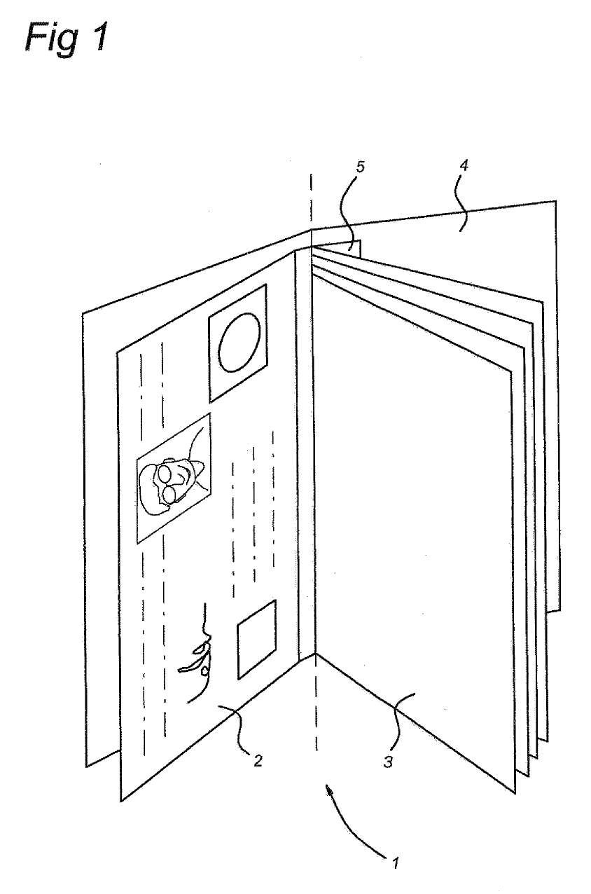

FIG. 1 shows diagrammatically a passport according to the invention;

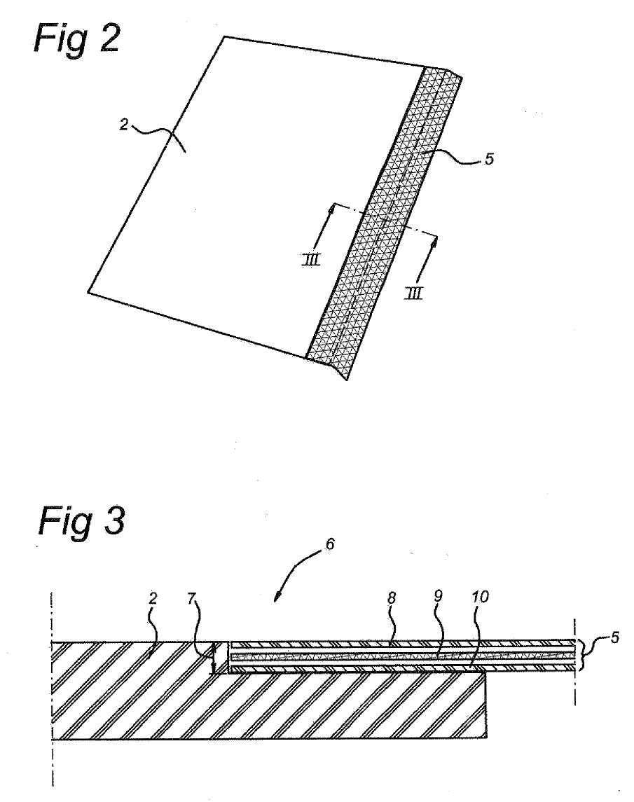

FIG. 2 shows the holder page of the passport including the hinged part;

FIG. 3 shows in detail the connecting point between non-hinged par and hinged part, on an enlarged scale;

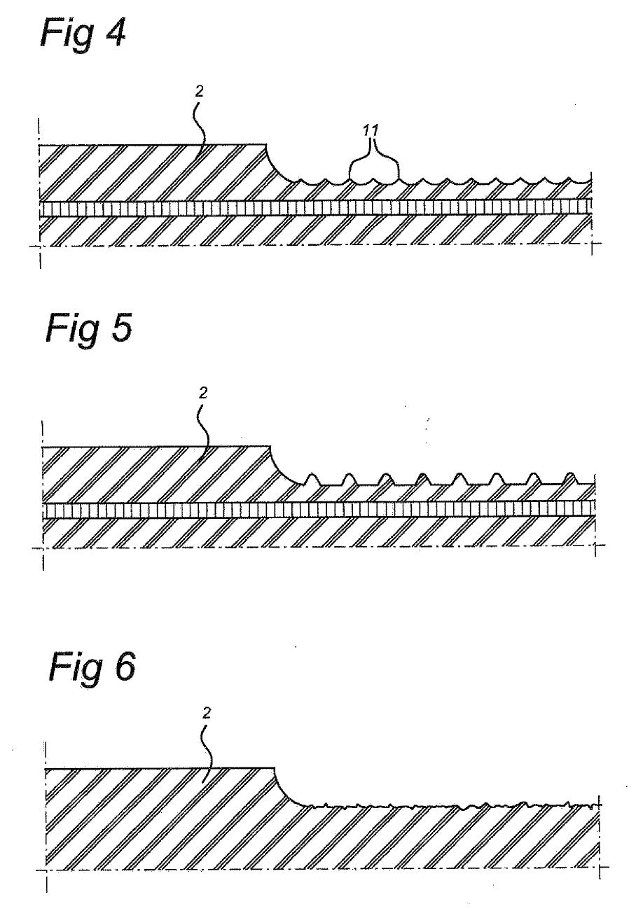

FIGS. 4-6 show various variants of the edge of the non-hinged part for connection to the hinged part.

A book-like construction such as a passport is indicated by 1 in FIG. 1. This construction is composed of a cover 4 in which a number of visa pages 3 are accommodated. A so-called holder page 2 made of a relatively stiff non-deformable material is also included. An example of such a non-deformable material is a polycarbonate material with a thickness between 0.5 and 1.0 mm. A chip and also a large number of security features, including a photograph of the holder, can be provided in such a holder page.

The thickness of the holder page 2 and the material of said page are such that said page cannot be hinged. For that reason, a hinged part 5 is fixed to it, as can be seen from FIG. 1. This hinged part 5 is connected both to the cover 4 and to the other visa pages 3. The connecting technique can comprise sewing, stapling, gluing and the like.

FIG. 2 shows diagrammatically in perspective the holder page including the hinged part 5 connected to it.

FIG. 3 shows a cross section at the position of the edge area in FIG. 2. It can be seen from this figure that the holder page 2 near the edge 6 is provided with a recess 7 whose height substantially corresponds to the thickness of the hinged part 5 after it has been fitted.

It can also be seen from FIG. 3 that the hinged part 5 is composed of two plastic layers, and more particularly polycarbonate layers 8 and 10, between which a fabric 9 is accommodated. It should be understood, however, that, when the hinged part 5 is being fixed to the holder page 2, these layers 8-10 are already integrated, in other words the distance between the various layers is no longer present, and the distinction between the layers can no longer be seen to that extent.

The hinged part 5 is preferably attached to the holder page 2 by fusing. For this purpose, the holder page 2 is made of a plastic that can be combined with the plastic of layer 10. This is preferably the same plastic material, such as polycarbonate material. The connection can be carried out in any way conceivable in the prior art by means of pressure and high temperature.

One possibility for connection is ultrasonic welding. Therein, the hinged part 5 is pressed against the holder page 2 with the transmission of high-frequency vibrations. In this way, heat is generated, which leads to fusion, and the lunged part and non-lunged part are joined together by means of the pressure.

In order to promote the effect of the high-frequency vibration, it is proposed according to the invention to provide part 2 with surface irregularity near recess 7. Various possibilities for such a surface irregularity are shown in FIGS. 4-6. Ridges 11 are shown in FIG. 4. The distance between the ridges is approximately 0.7 mm, while the height of said ridges relive to the lowest point of the ridges is approximately 0.1-0.2 mm. FIG. 5 shows ribs, while FIG. 6 shows an unordered surface irregularity. All these embodiments have been found suitable for the concentration of energy during high-frequency welding. It will be understood that other surface shapes are also possible.

The surface irregularities shown here can be produce dug the injection moulding or production in another way of the holder page. It is also possible to obtain such an irregularity by means of a subsequent cutting or stamping step. It will be understood that it is likewise possible to produce the irregularity in layer 10 or both in layer 10 and in the edge part of the holder page 2.

It has been found that, when a hinged part 5 is fixed to a non-hinged part 2 in such a way, a particularly sturdy construction is obtained with binge movements made in the normal way, the bond will not break, even with hinge movements made more than 50,000 times. Furthermore, the attachment been holder page 2 and hinged part 5 is so intimate that it is not possible to remove the hinged part 5 without great damage to the holder page.

After the above, variants will immediately be obvious for the person skilled in the art, in particular combinations with known techniques from the prior art. These are obvious and lie within the scope of the appended claims, in which rights are expressly requested for variants that fall exclusively under the subclaims.

1-13. (canceled)

14. Method for producing a first, non-hinged part made of plastic material and a hinged part fixed to it, comprising providing a fabric-reinforced hinged part, providing a first part provided in an area with surface irregularities, placing said hinged part on said area with surface irregularities, and ultrasonically connecting said first part and said hinged part at that point.

15. Method according to claim 14, in which the provision of surface irregularities comprises providing a ribbed structure.

16. Method according to claim 15, in which said ribs comprise ribs extending parallel to each other.

17. Method according to claim 14, in which the provision of a fabric-reinforced part comprises providing two plastic layers, accommodating fabric reinforcement between them and fusing said plastic layers together.

18. Method according to claim 14, in which the connection of said first part and said hinged part comprises gluing.

19. Method according to claim 14, in which said connection of said hinged part and said first part comprises mechanical connection.

20. Book-like structure comprising a non-hinged first part made of plastic material and a second part, a hinged part being fixed on said non-hinged first part and said hinged part and said second part being connected to each other, and said hinged part being fixed on said first part by fusing, said hinged part comprising a plastic material reinforced with fabric in which said plastic material corresponds to the plastic material of said first part.

21. Structure according to claim 20, in which said fabric comprises a polyester fabric.

22. Structure according to claim 20, in which said first part at the position of said hinged part comprises a recess for receiving said hinged part.

23. Structure according to claim 20, comprising a passport.

24. Structure according to claim 20, in which said hinged part is fixed on said first part by gluing.

25. Structure according to claim 20, in which said hinged part is fixed on said first part by mechanical means.
